(19) United States
(12) Patent Application Publication
(10) Pub. No.: US 2025/0136323 A1
(43) Pub. Date: May 1, 2025

(54) DUAL CONNECTOR

(71) Applicant: The Stanley Works Israel Ltd., Rosh Ha'Ayin (IL)

(72) Inventors: Adar OMRY, Hertzeliya (IL); Gal AVIGAD, Gonen (IL)

(73) Assignee: The Stanley Works Israel Ltd., Rosh Ha'Ayin (IL)

(21) Appl. No.: 18/933,071

(22) Filed: Oct. 31, 2024

Related U.S. Application Data
(60) Provisional application No. 63/623,461, filed on Jan. 22, 2024.
(60) Provisional application No. 63/546,753, filed on Oct. 31, 2023.

(51) Int. Cl. B65D 21/02

(52) U.S. Cl. CPC B65D 21/023

(57) ABSTRACT

A dual connector having a main body is disclosed. The connector includes a body having inner and outer ledges and a slider having inner and outer tabs disposed on the body opposite the ledges. The main body can be connected to a surface. A first container having a first longitudinal dimension and two steps can be secured to the connector by securing the inner ledge over one step and the inner tab over the other step. A second container have a longer longitudinal dimension can be secured to the connector by securing the outer ledge over one step and the outer tab over the other step. In this manner, two containers having different lengths can be secured to a surface.

### CROSS REFERENCE TO RELATED APPLICATIONS

This application claims the benefit of U.S. Provisional Application No. 63/623,461 filed on Jan. 22, 2024, and also, this application claims the benefit of U.S. Provisional Application No. 63/546,753 filed on Oct. 31, 2023. The entire disclosure of each of the above applications is incorporated herein by reference.

### FIELD OF THE INVENTION

The present invention relates to a dual connector which provides a manner for securing stackable storage containers of different sizes onto a surface.

### BACKGROUND

Stackable storage containers are known, for example, the rolling container assembly shown in U.S. Pat. Nos. 8,132,819 and 9,132,543, which are hereby incorporated by reference. The assembly disclosed therein includes a base storage container which is disposable on a cart which is provided with wheels and an integral handle system. At least one further storage container may be removably attached on top of the base container, allowing for multiple containers to be jointly transported. The mechanism for attaching the containers to each other in such systems may include a stacking latch mechanism, for example, as shown in U.S. Patent Application Publication Nos. 2020/0025229 and 2020/0298392 and U.S. Pat. No. 11,486,427, which are hereby incorporated by reference. The mechanism includes a spring loaded pivotable latch having a hook disposed on the lid of the container and a step formed on the lower housing of the container. The latch hook is selectively disposable over the step to thereby secure the containers together. U.S. Pat. No. 8,505,729 discloses a stackable container system in which each container includes a latch member and a ledge formed on the outer surface. The latch of a lower container is foldable over the ledge of an upper container to secure the upper and lower containers together.

With further reference to Prior Art FIG. 37 components of a known stackable system are shown. Container 380 includes base 395 having an interior storage volume and cover 396 pivotably attached to base 395. Base 395 includes step 393 extending downwardly from a lower side edge thereof. Though not shown, a second step having the same structure extends downwardly from the opposite lower side edge. Spring biased latch 392 extends upwardly from the upper side edge of cover 396. Though not shown a second spring biased latch having the same structure would extend upwardly from the opposite side edge of cover 396. T-Tab 391 extends upwardly from a central region of cover 396 and has two overhanging ledges. T-Tab 391 may be raised or lowered from the upper surface of cover 396. Conventional accessory box 394 includes base 398 and pivotable cover 397 disposed thereon. Step 393′ having the same structure as step 93 extends downwardly from a lower long side edge thereof. Though not shown a second step having the same structure would extend from the opposite long side edge thereof. Spring biased latch 392′ having the same structure as spring biased latch 392 extends upwardly from the front side edge of cover 397. To secure accessory box 394 onto container 390, step 393′ is inserted beneath a ledge of raised T-Tab 391, and the opposite side step is secured beneath the second spring biased latch of container 390. The not shown second step 393′ contacts the hook of the not shown second latch 392 to rotate latch 392 outwardly until step 393′ clears the hook to allow latch 392 to rotate back inwardly under the spring bias such that the hook overlies step 393′. Alternatively, T-Tab 391 could be lowered and a container having substantially the same overall lower surface area as the upper surface of cover 396 of container 390 could be secured between spring biased latch 392 and the not shown second latch 392. A further container could be secured on cover 397 between spring biased latches 392′. The structure of latches 392,392′ and steps 393,393′ could, for example, have the structure as shown in the above-referenced published patent applications and patents.

With reference to Prior Art FIG. 38 a further known stackable storage system is disclosed. The stackable storage system includes a plurality of stackable storage containers 360(a), 360(b) and 360(c), of substantially the same surface area but having varying depth, each of which includes a cover having latch mechanisms 392 disposed thereon. Containers 360(b) and 360(c) each have steps 393. Chest 360(c) is the lowest container of the stack and may be integrally formed with wheels and an upright pull handle to allow the stackable storage system to be transported by tilting and rolling. Upper container 360(a) has the same structure as container 90 described above. The incorporation of latches 392, steps 393, and a T-Tab not shown in (FIG. 38) allows containers of various depths and surface areas to be incorporated into and secured in the stackable storage system.

### SUMMARY OF THE INVENTION

In a first embodiment the invention is directed a connector having a main body. A first peripheral ledge is formed on the main body and extends adjacent one side of the main body. A second peripheral ledge is formed on the main body. The second peripheral ledge is disposed inwardly of the first peripheral ledge. A slider is slidably disposed on an opposite side of the main body. The slider has a slider body slidable between an outer position relative to the main body and an inward position relative to the main body. The slider body includes a first inwardly extending tab and a second inwardly extending tab. The second tab is disposed at a location which is inward of the first tab. A first container having a first container first step extending downwardly from one side and a first container second step extending downwardly from an opposite side can be secured to the main body with the first container first step secured beneath the first peripheral ledge and the first container second step secured beneath the first tab. A second container having a second container first step extending downwardly from one side and a second container second step extending downwardly from an opposite side can be secured to the main body with the second container first step secured beneath the second peripheral ledge and the second container second step secured beneath the second tab.

In a further embodiment the invention is directed to a connector having a main body. The connector includes a peripheral ledge formed on the main body and extending adjacent one side of the main body. A slider is slidably disposed on an opposite side of the main body. The slider has a slider body slidable between an outer position relative to the main body and an inward position relative to the main body. The slider body includes an inwardly extending tab. A container having a container first step extending downwardly from one side and a container second step extending downwardly from an opposite side can be secured to the main body with the container first step secured beneath the peripheral ledge and the container second step secured beneath the tab.

In a further embodiment, the invention is directed to a system including a connector and a storage container. The connector includes a main body and a first peripheral ledge formed on the main body and extending adjacent one side of the main body. The connector also includes a slider slidably disposed on an opposite side of the main body. The slider has a slider body slidable between an outer position relative to the main body and an inward position relative to the main body. The slider body includes an inwardly extending tab. The storage container includes two first container steps extending downwardly from one side and two second container steps extending downwardly from an opposite side. One of the first container steps is disposed opposite one of the second container steps to create a first container step pair, and the other of the first container steps is disposed opposite the other of the second container steps to create a second container step pair. The storage container can be secured simultaneously upon the main bodies of two of the connectors with the first container step of the first container step pair secured beneath the peripheral ledge of a first of the connectors and the second container step of the first container step pair secured beneath the tab of the first of the connectors, and with the first container step of the second container step pair secured beneath the peripheral ledge of a second of the connectors and the second container step of the second container step pair secured beneath the tab of the second of the connectors.

In a further embodiment the invention is directed to a connector having a main body and a first outer peripheral ledge and a second outer peripheral ledge formed on the main body and extending adjacent one side of the main body. The connector further includes a first inner peripheral ledge and a second inner peripheral ledge formed on the main body, with the first inner peripheral ledge extending inwardly of the first outer peripheral ledge to form a first peripheral ledge pair. The second inner peripheral ledge extends inwardly of the second outer peripheral ledge to form a second peripheral ledge pair. The connector includes a first slider slidably disposed on an opposite side of the main body and disposed opposite of the first peripheral ledge pair. The first slider is slidable between an outer position relative to the main body and an inward position relative to the main body. The first slider includes a first slider first inwardly extending tab and a first slider second inwardly extending tab, with the first slider second inwardly extending tab disposed at a location which is laterally inward of the first slider first inwardly extending tab to form a first slider inwardly extending tab pair which is disposed opposite the first peripheral ledge pair. The connector includes a second slider slidably disposed on an opposite side of the main body and disposed opposite of the second peripheral ledge pair. The second slider is slidable between an outer position relative to the main body and an inward position relative to the main body. The second slider includes a second slider first inwardly extending tab and a second slider second inwardly extending tab. The second slider second inwardly extending tab is disposed at a location which is laterally inward of the second slider first inwardly extending tab to form a second slider inwardly extending tab pair which is disposed opposite the second peripheral ledge pair.

These and other objects, features, and characteristics of the present invention, as well as the methods of operation and functions of the related elements of structure and the combination of parts will become more apparent upon consideration of the following description and the appended claims with reference to the accompanying drawings, all of which form a part of this specification, wherein like reference numerals designate corresponding parts in the various figures. It is to be expressly understood, that the drawings are for the purpose of illustration and description only, and are not intended as a definition of the limits of the invention. In addition, it should be appreciated that structural features shown or described in any one embodiment herein can be used in other embodiments as well. As used in the specification and in the claims, the singular form of “a”, “an”, and “the” include plural references unless the context clearly dictates otherwise.

### BRIEF DESCRIPTION OF THE DRAWINGS

FIG. 1 is an overhead perspective view of a dual connector according to the invention attached to a surface.

FIG. 1A is a close-up perspective view of a portion of a dual connector according to a second embodiment.

FIG. 2 is an overhead view of the dual connector as shown in FIG. 1.

FIG. 3 is front side perspective view of the dual connector shown in FIG. 1.

FIG. 4 is an underside perspective view of the dual connector shown in FIG. 1.

FIG. 5 is a right side perspective view of the dual connector shown in FIG. 1.

FIG. 6 is an overhead perspective view of the dual connector shown in FIG. 1 with the slider forming part of the dual connector not shown.

FIG. 7 is an overhead perspective view of the slider lock forming part of the dual connector shown in FIG. 1.

FIG. 8 is a left side view of the slider lock shown in FIG. 7 with and the latch slider and spring shown and the latch cover not shown.

FIG. 9 is a right side view of the latch slider and spring shown in FIG. 8

FIG. 10 is a left side view of the slider lock shown in FIG. 7.

FIG. 11 an overhead perspective view of the slider and slider lock forming part of the dual connector shown in FIG. 1.

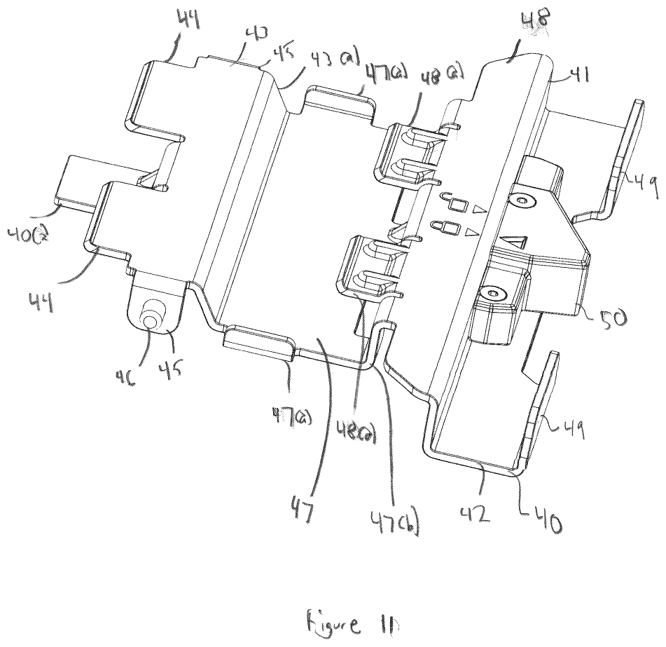

FIG. 12 is a side perspective view of the slider shown in FIG. 11 with the slider lock not shown.

FIG. 13 is an overhead right side perspective view of a slider according to a second embodiment.

FIG. 13A is a side perspective view of the slider shown in FIG. 13 with the lock shown.

FIG. 13B is an overhead perspective view of the slider shown in FIG. 13.

FIG. 14 is an underside perspective view of the slider and slider lock shown in FIG. 11.

FIG. 15 is a close up underside perspective view of the slider and slider lock shown in FIG. 11 disposed on the main body form parting of the dual connector shown in FIG. 1.

FIG. 16 is an overhead perspective view of the slider shown in FIG. 11 having a second embodiment of a slider lock which includes a safety lock.

FIG. 16A is a close up underside perspective view of the slider and slider lock and safety lock as shown in FIG. 16.

FIG. 16B is an over an overhead perspective view of the slider shown in FIG. 16 with the slider lock shown and the slider lock cover not shown.

FIG. 17 is an overhead perspective view of the slider lock shown in FIG. 16.

FIG. 18 is perspective view of the slider lock shown in FIG. 17 with the sliding lock cover not shown.

FIG. 19 is perspective of the slider lock shown in FIG. 18 with the cover and latch tooth not shown.

FIG. 20 is a perspective view of a storage case.

FIG. 21 is a perspective view of the storage case shown in FIG. 20 from the opposite side.

FIG. 22 is a perspective view of the storage case shown in FIG. 20 disposed on the connector shown in FIG. 1.

FIG. 23 is a perspective view of the storage case shown in FIG. 20 disposed on the connector shown in FIG. 1 from the opposite side.

FIG. 24 is a close up overhead view of the storage case shown in FIG. 20 disposed on the connector shown in FIG. 1.

FIG. 25 is a perspective view of a second storage case.

FIG. 26 is a perspective view of the second storage case shown in FIG. 25 from the opposite side.

FIG. 27 is an underside perspective view of the second storage case shown in FIG. 25.

FIG. 28 is a perspective view of the storage case shown in FIG. 25 disposed on the connector shown in FIG. 1.

FIG. 29 is a perspective view of the storage case shown in FIG. 25 disposed on the connector shown in FIG. 1 from the opposite side.

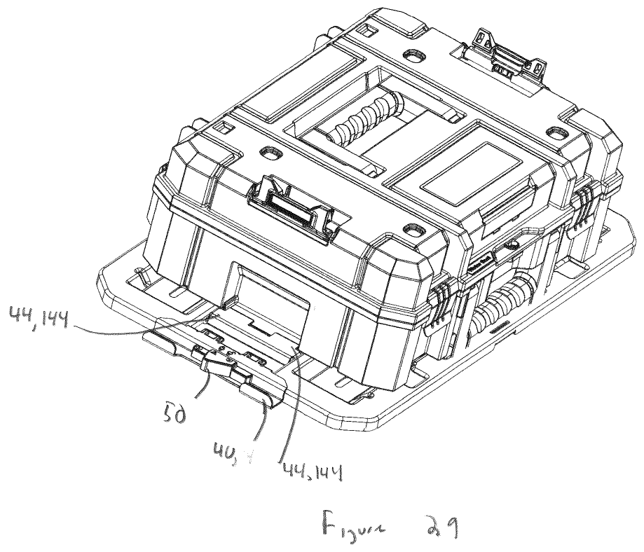

FIG. 30 is a view of a third storage case disposed on two connectors as shown in FIG. 1.

FIG. 31 is a view of a third storage case disposed on two connectors shown in FIG. 30 from the opposite side.

FIG. 32 is a perspective view of a connector according to a second embodiment.

FIG. 33 is a perspective view of the storage cases shown in FIGS. 20 and 25 disposed on the connector shown in FIG. 32.

FIG. 34 is a perspective view of the storage cases shown in FIGS. 20 and 25 disposed on the connector shown in FIG. 32 from the opposite side.

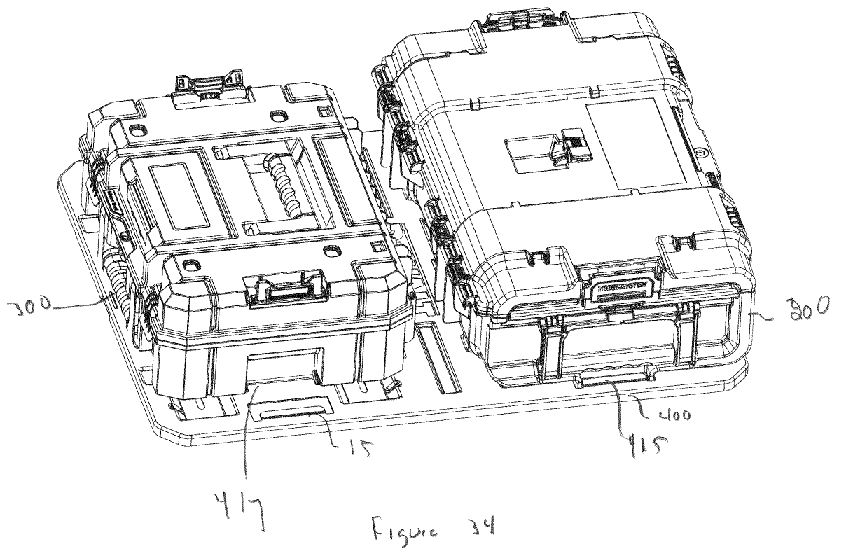

FIG. 35 is a perspective view of the third storage case shown in FIG. 30 disposed on the connector shown in FIG. 32.

FIG. 36 is a perspective view of the third storage case shown in FIG. 30 disposed on the connector shown in FIG. 32 from the opposite side.

FIG. 37 is a view of a stackable storage system according to the prior art.

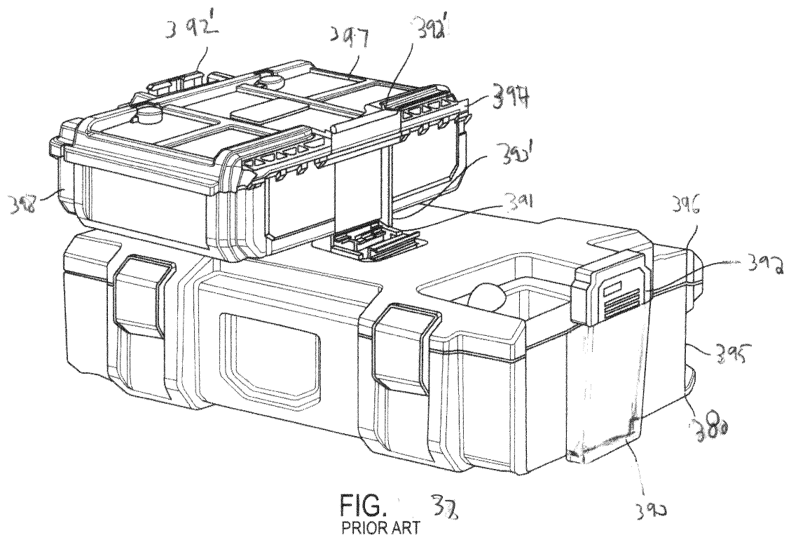

FIG. 38 is a view of a second stackable storage system according to the prior art.

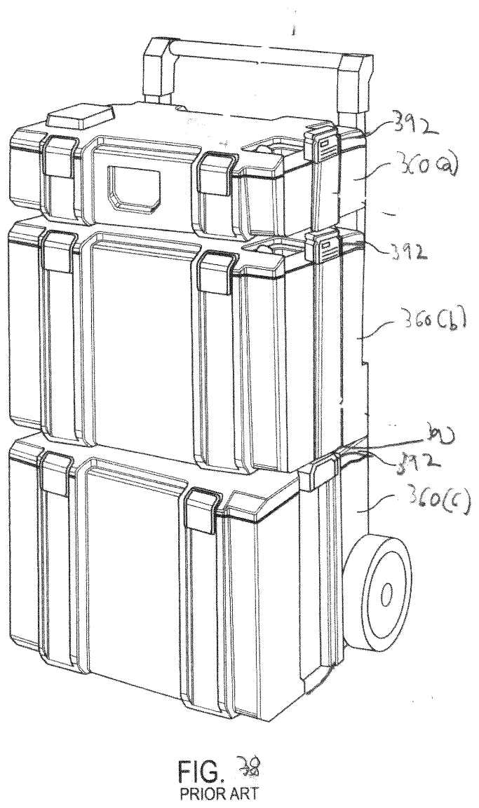

### DETAILED DESCRIPTION OF EXEMPLARY EMBODIMENTS

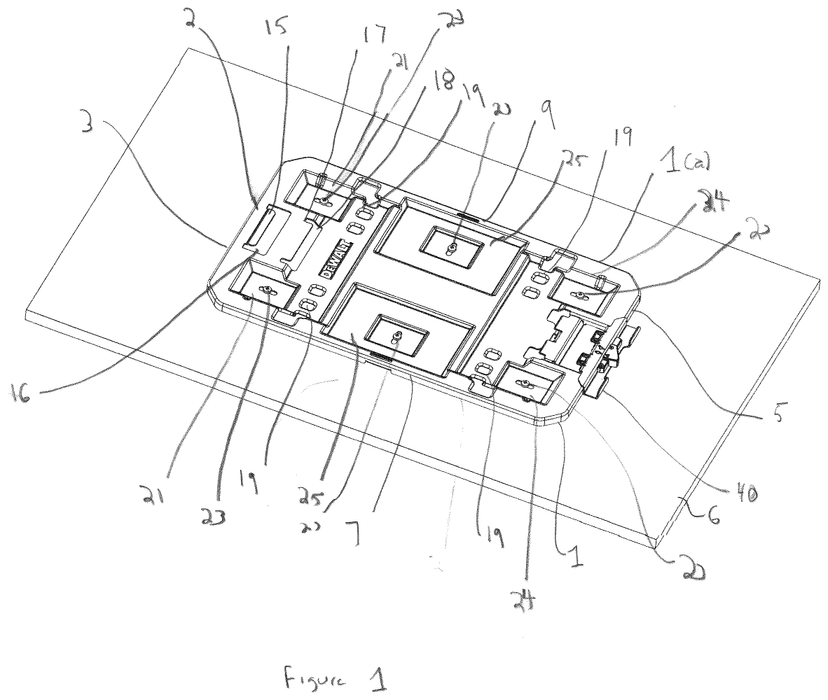

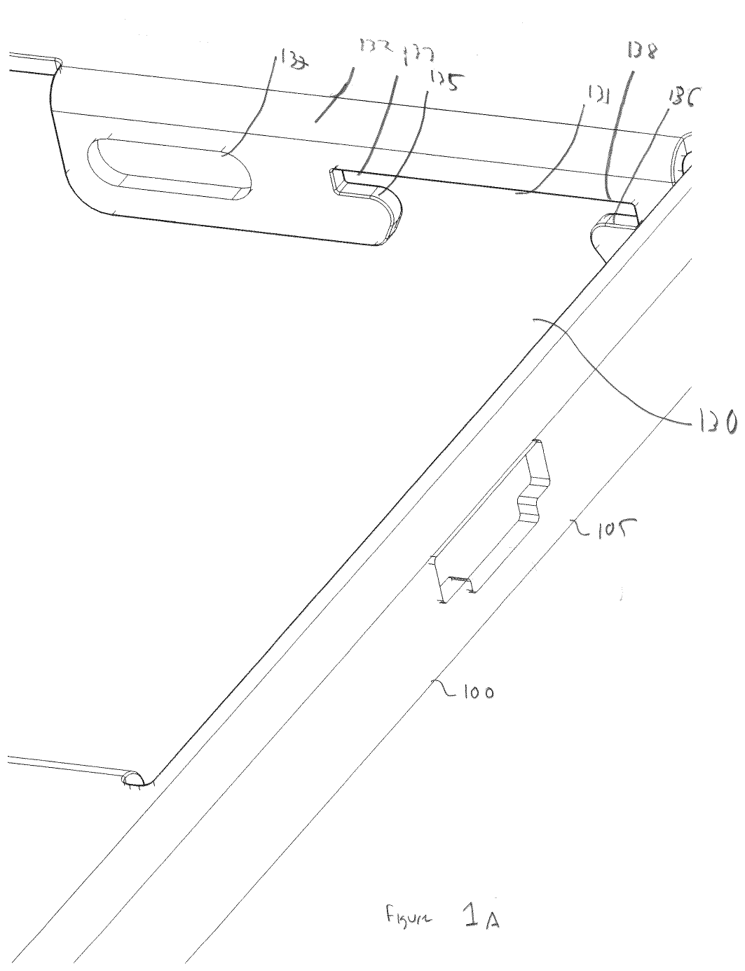

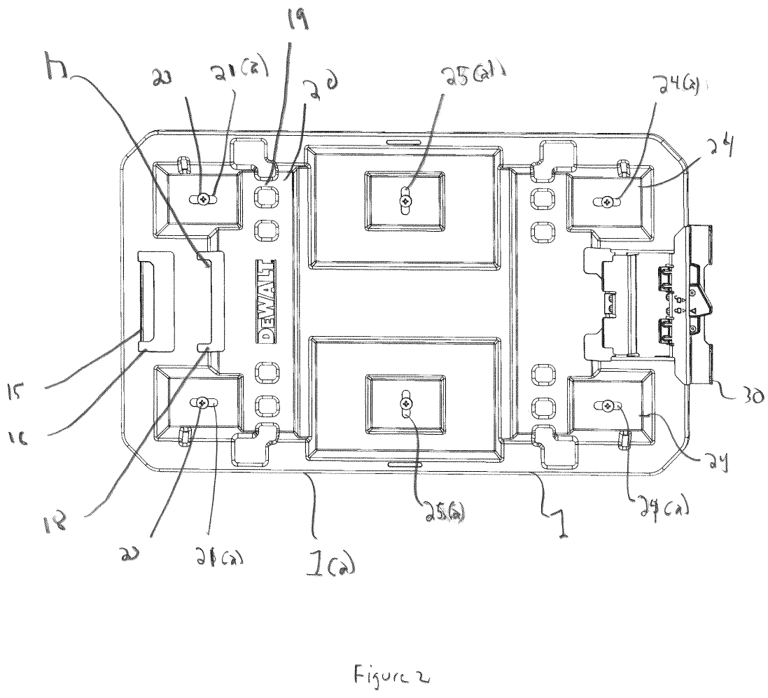

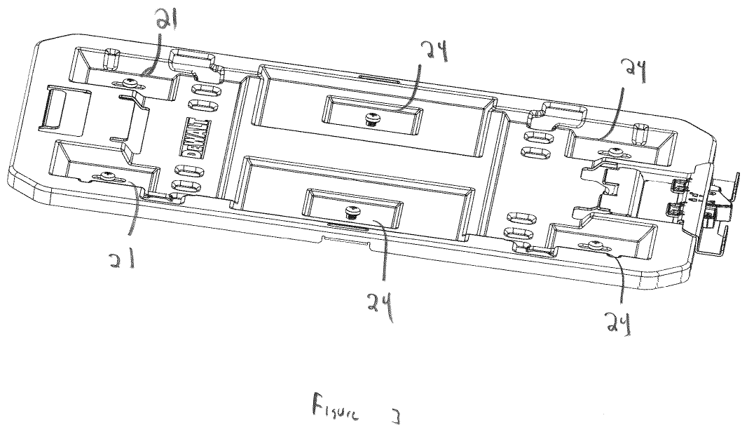

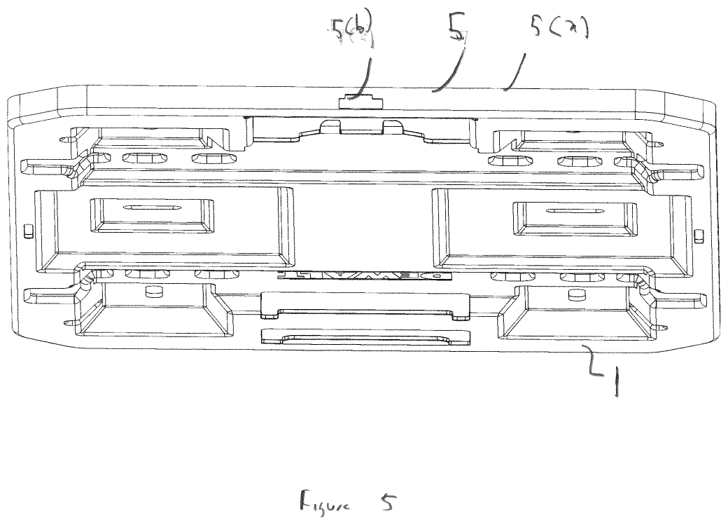

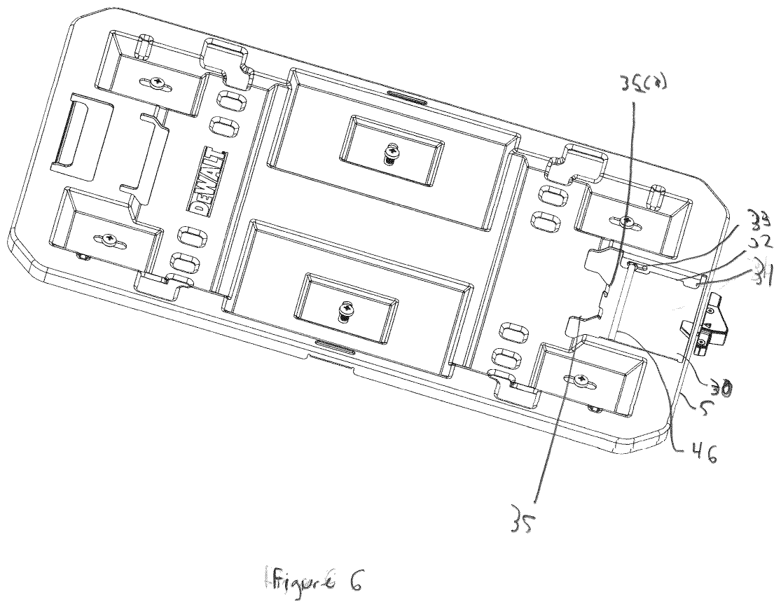

With reference to FIGS. 1-6, dual connector 1 includes main body 1(a) having left lateral short edge or wall 3, right lateral short edge or wall 5, front longitudinal long edge or wall 7 and rear longitudinal long edge or wall 9. Main body 1(a) is stamped out of sheet metal. The use of the terms front, rear, left, right, short and long are for the sake of description only and are not intended to limit the invention. Additionally, for the sake of convenience of description only, the direction extending between left lateral short edge 3 and right lateral short edge 5 shall be referred to as the longitudinal direction, and the direction between front longitudinal long edge 7 and rear longitudinal long edge 9 shall be referred to as the lateral direction. Dual connector 1 further includes upper surface 11 and lower surface 13. Upper surface 11 includes a perimeter region 2 which extends inwardly from the edges. Left outer peripheral ledge 15 extends inwardly and slightly upwardly from perimeter region 2 at left lateral short ledge 3, above through opening 16 formed through dual connector 1. Left inner peripheral ledge 17 extends inwardly from opening 16 in the longitudinal direction, and is disposed at a level slightly below outer peripheral ledge 15. Ledge 17 extends above through opening 18. Ledge 17 extends at generally the same level as perimeter 2. With reference to FIGS. 5-6, right lateral short edge 5 includes wall portion 5(a) extending to the right of and defining right through opening 30 formed in main body 1(a). Slot 5(b) is formed through wall portion 5(a). Slot 5(b) has a truncated T-shape such that the width in the vertical direction is greater at the center region thereof than on the side regions as taken in the lateral direction.

Depressed left flat surface 20 extends inwardly of opening 18 and substantially laterally across upper surface 11, at a level below perimeter 2 and ledges 15 and 17. Dual connector 1 further includes two pairs of rectangular though holes 19 extending through left flat surface 20. The undersides of through holes 19 include rims 19(a) which extend about the perimeter of holes 19 and project downwardly from lower surface 13. Front and rear left side depressions 21 are formed in the left front and rear side corners of main body 1(a) of connector 1. One depression 21 is disposed in front of ledges 15 and 17, and one depression 21 is disposed behind ledges 15 and 17 as taken in the lateral direction. Depressions 21 include longitudinally extending oval slots 21(a) formed therethrough. One securing screw 23 extends through each oval slot 21(a).

Front and rear central depressions 25 extend to the right of holes 19 and have substantially the same structure as depressions 21, except they are wider and longer. Depressions 25 include laterally extending oval slots 25(a) formed therethrough, with one securing screw 23 extending through each slot. Front and rear right depressions 24 are identical in structure to depressions 21 and include longitudinally extending oval slots 24(a) formed therethrough, with one securing screw 23 extending through each slot 24(a). Depressions 24 extend inwardly from perimeter region 2 at right lateral short edge 5. A pair of through holes 19 is formed between each of front right depression 24 and front central depression, and a pair of through holes 19 is formed between rear right depression 24 and rear central depression 25.

With reference to FIG. 1, dual connector 1 can be secured to surface 6 via screws 23 which extend through main body 1(a) and into the surface.

With further reference to FIG. 6 in particular, slider through opening 30 extends through main body 1(a) from wall portion 5(a) of right edge 5 at a location between right side depressions 24. Slot 5(b) is disposed at the location of slider through opening 30. Slider walls 31 project downwardly from upper surface 11 on either side of opening 30 and include oval openings 33 formed therein. Channel slide openings 32 are formed in slider walls 31 rightward of oval openings 33. Connector main body 1(a) further includes right projection 35 extending into opening 30. Projecting tabs 35(a) extend rightward from right projection 35 and bend downwardly.

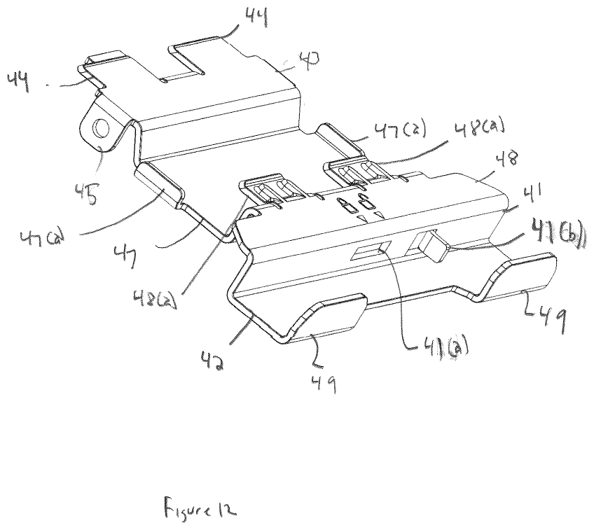

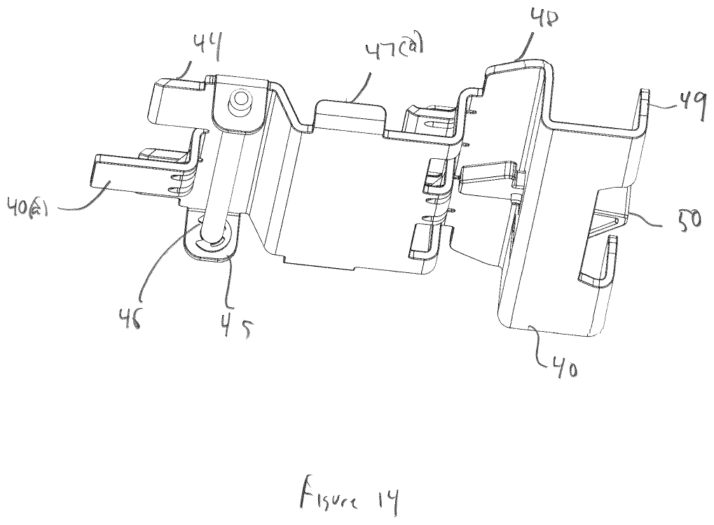

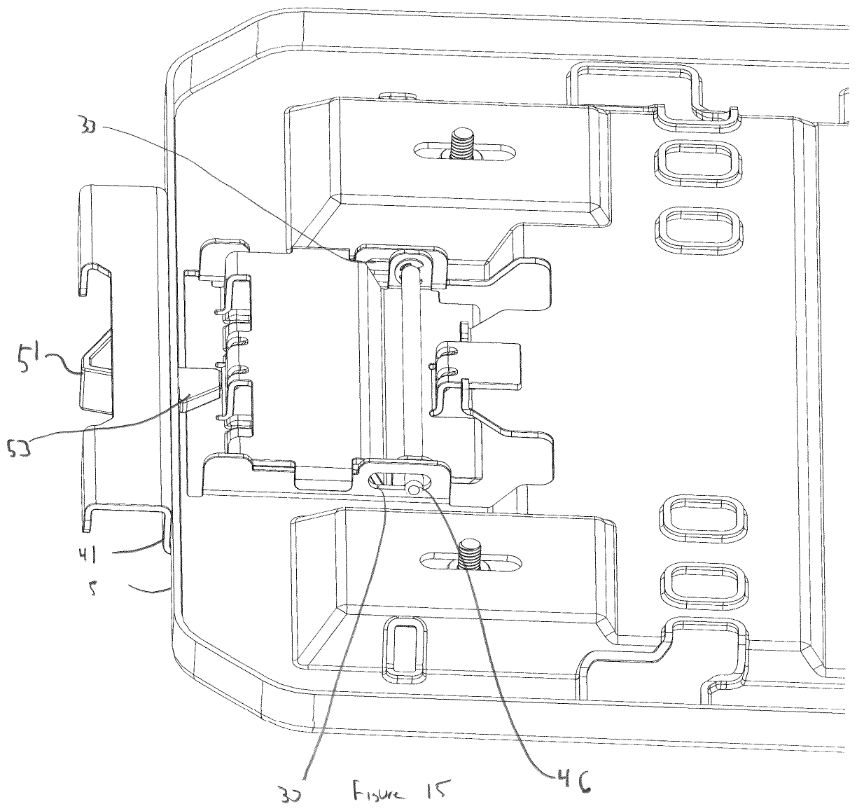

With reference to FIGS. 12 and 14 and 15, slider 40 includes laterally inward raised surface 43 at the left edge. Slider 40 is stamped out of sheet metal. Front and rear projection tabs 44 extend leftward from raised surface 43 in a direction parallel to upper surface 11 of main body 1(a). Forwardly projecting tab 40(a) is disposed below tabs 44 and is located below the space formed between tabs 44. Front and rear side tabs 45 extend downwardly from the lateral edges of raised surface 43 and receive sliding rod 46 through openings formed therein. Rightward of raised surface 43, slider 40 includes a wall which extends downwardly towards laterally inward lower surface 47. Surface 47 is substantially parallel to surface 43. Front and rear lateral tabs 47(a) extend outwardly and upwardly from surface 47, with the upward portion extending substantially perpendicular to surface 47. Rightward of inward lower surface 47, slider 40 includes a wall which extends upwardly into laterally inward upper surface 48 which is substantially parallel to surfaces 43 and 47. Front and rear slider locking tabs 48(a) extend leftward from upper surface 48 substantially parallel to upper surface 11. The overall lateral distance between the front edge of front tab 48(a) and the rear edge of rear tab 48(a) is less than the overall lateral distance between the front edge of front tab 44 and the rear edge of rear tab 44. In other words, the lateral span of tabs 48(a) is less than that of tabs 44. Tabs 44 are also disposed inwardly of tabs 48(a) in the longitudinal direction. Rightward of upper surface 48, slider 40 includes wall 41 which extends downwardly into laterally outward lower surface 42 which is substantially parallel to surfaces 43, 47 and 48. Wall 42 includes through opening 41(a). Wall 41 further includes rearwardly projecting tab 41(b) extending substantially perpendicular thereto. Front and rear vertically disposed slider push/pull tabs 49 are formed at the outer most edge of lower surface 42. A channel is formed between walls 41 and tabs 49. Slider lock 50 is disposed in the channel.

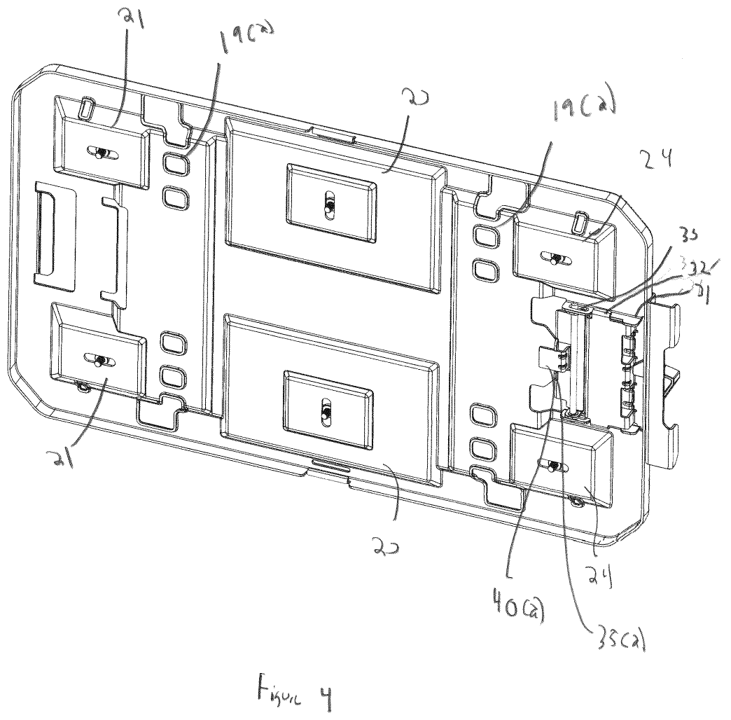

With reference to FIGS. 1 and 4, slider 40 is secured on main body 1(a) with the extending edges of sliding rod 46 fitting within oval openings 33 in walls 31, tabs 47(a) fitting behind channel slide openings 32, and upper surface 48 resting on wall portion 5(a) of right lateral short edge 5. The width of surface 48 is greater than that of wall portion 5(a) to thereby allow slider 40 to be pushed or pulled from an innermost position to an outermost position with the travel distance defined by the length of the oval openings 33 in walls 31. Accordingly, the locations of tabs 44 and 48(a) relative to the lateral center of main body 1(a) are movable to the same extent. Tabs 44 and 48(a) are disposed opposite ledges 15 and 17 formed on left lateral edge 3. The distance in the longitudinal direction between tabs 48(a) and outer ledge 15 is greater than the distance in the longitudinal direction between tabs 44 and inner ledge 15. Forwardly projecting tab 40(a) slidably fits between projecting tabs 35(a) to provide lateral stabilization for slider 40.

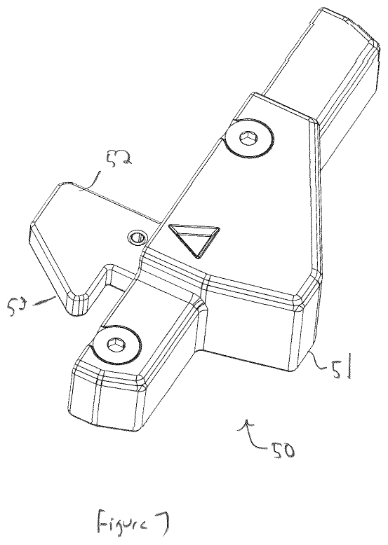

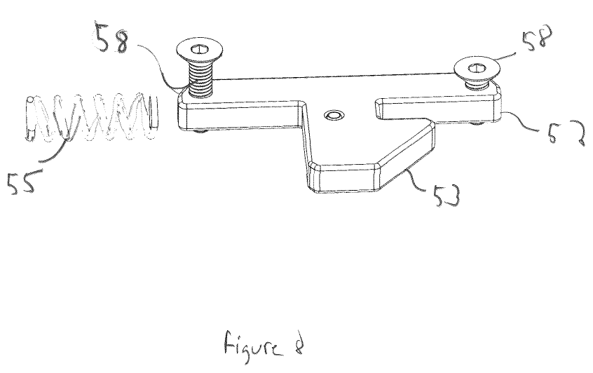

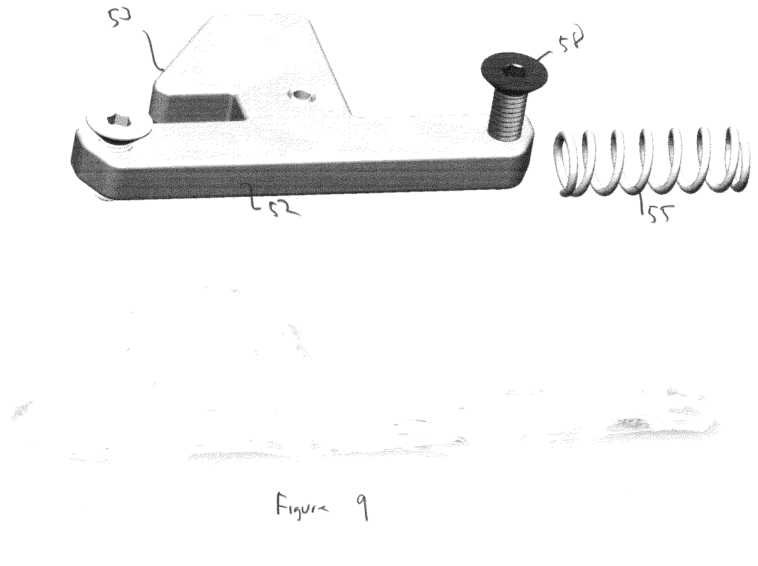

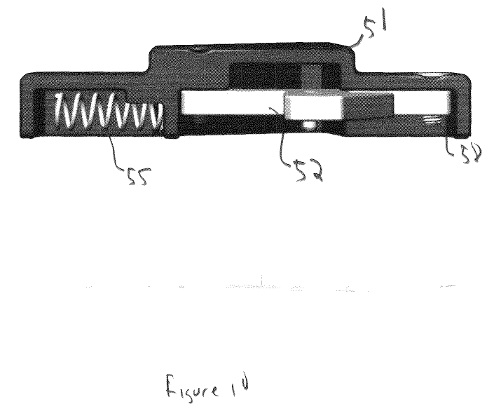

With reference to FIGS. 7-10, slider lock 50 is disclosed. Slider lock 50 includes slider lock cover 51 made of plastic and has an open leftward face. The right edge of lock cover 51 extends laterally rearwardly of rearwardly projecting tab 41(b) such that tab 41(b) is disposed within lock cover 51. Latch tooth 52 is made of metal and has a truncated H-shape and is secured to and within lock cover 51 by rivets 58. Latch tooth 52 includes slider lock element tab 53 extending inwardly from and forming a gap with a main body portion of tooth 52. Slider lock 50 is disposed on lower surface 42 of slider 40. Lock element tab 53 extends leftward of the open face of lock cover 51 and is disposed through both opening 5(b) in wall portion 5(a) and opening 41(a) in slider 40 such that both wall portion 5(a) and slider wall 41 fit within the H-shape defined by tooth 52. Spring 55 is disposed within an open area of lock cover 51 and is disposed between tab 41(b) and latch tooth 52 and biases cover 51 and latch tooth 52 forwardly towards front longitudinal edge 7 such that lock element tab 53 is not aligned with either opening 41(a) or opening 5(b), preventing slider 40 from being pulled laterally outwardly. When lock cover 51 and thus tooth 52 are moved to the rear against the bias of spring 55, tab 53 is aligned with openings 41(a) and 5(b), aligned and slider 40 can be slid rearwardly with tab 53 fitting through the openings. Thus, lock 50 is biased to lock slider 40 when slider 40 is in the laterally inward position. When slider 40 is in the laterally outward position the front edge of tab 53 is slanted such that when slider 40 is pushed inward the contact of the slanted surface pushes tooth 52 rearwardly against the spring bias to allow tooth 52 to move through openings 41(a) and 5(b). Once tab 53 clears openings 41(a) and 5(b), the bias provided by spring 55 pushes latch tooth 52 such that tab 53 is not aligned with the openings.

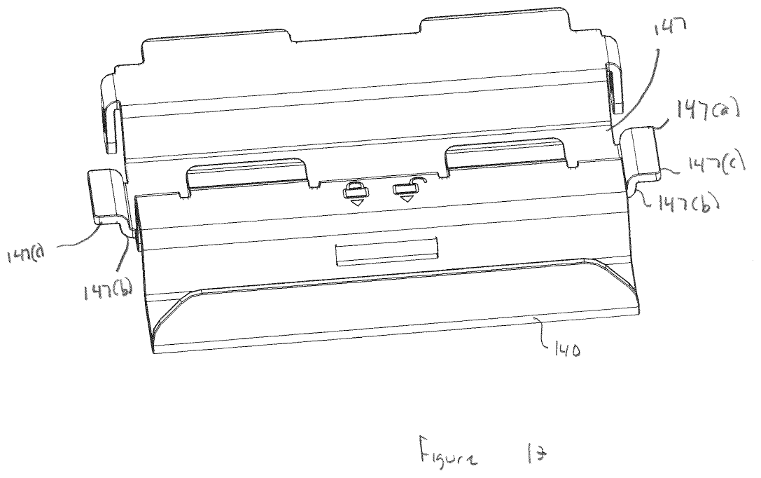

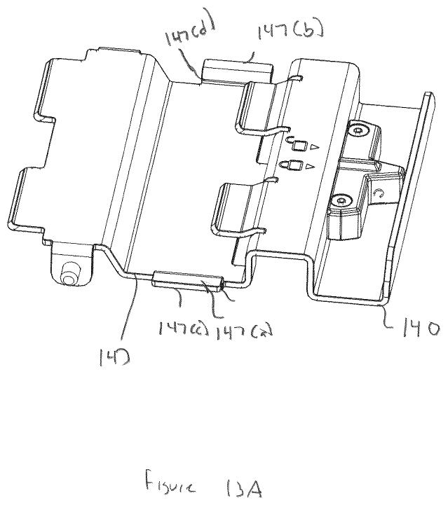

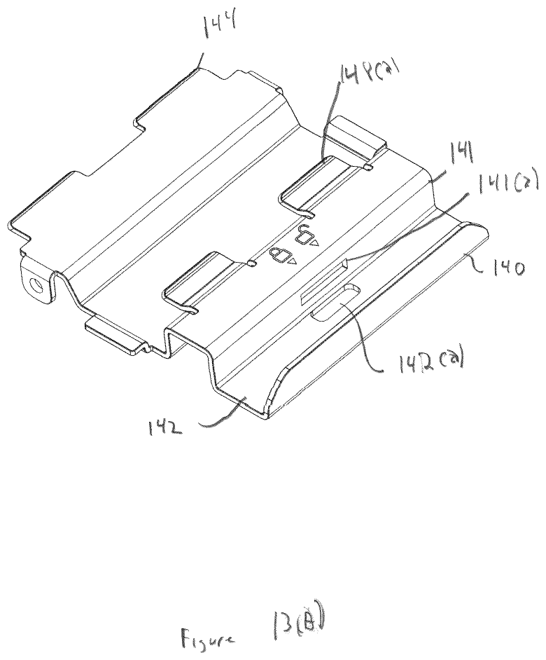

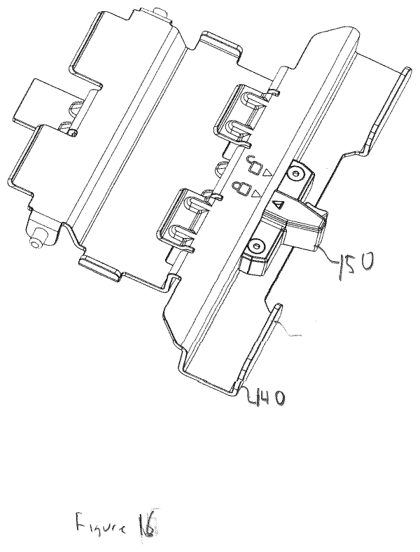

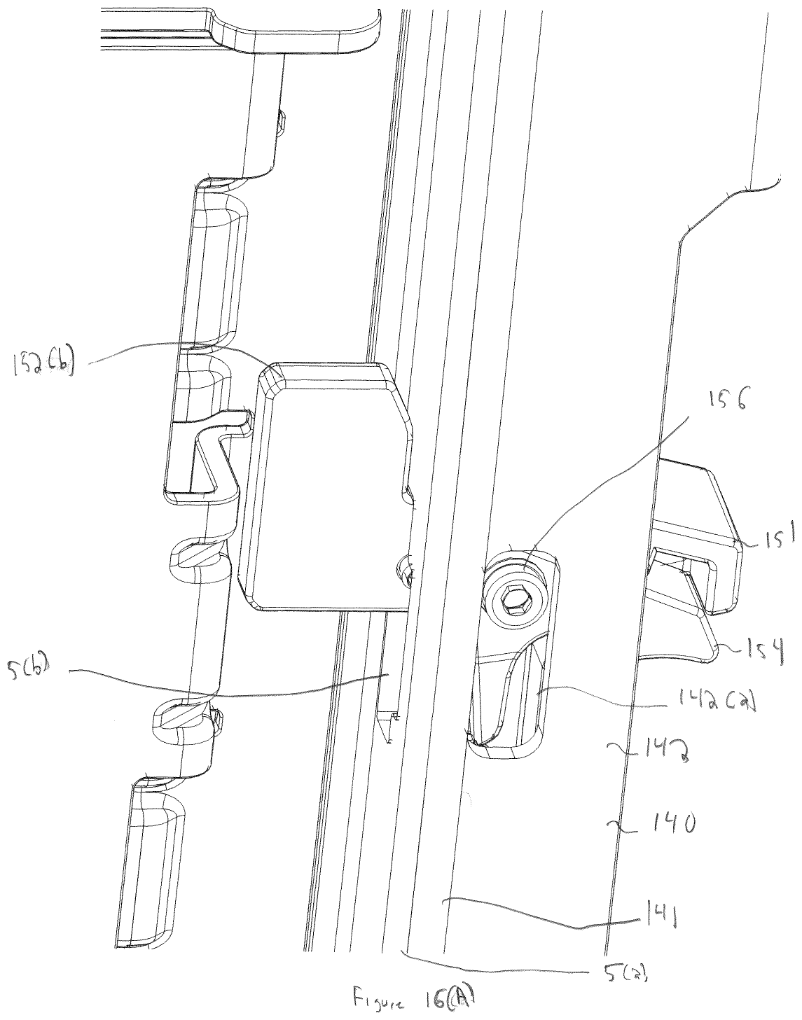

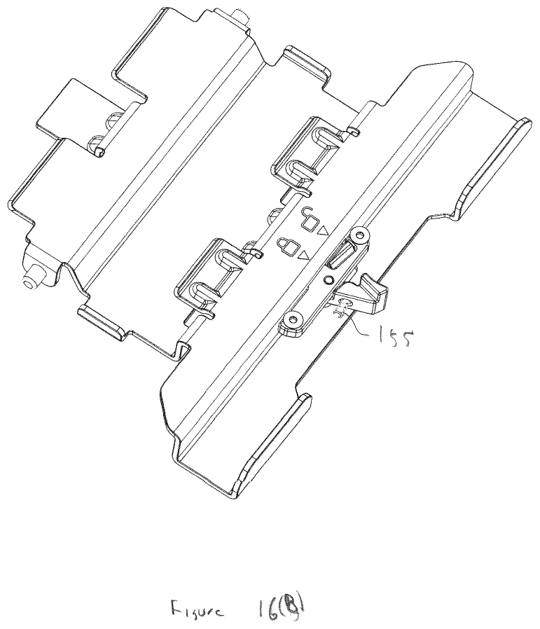

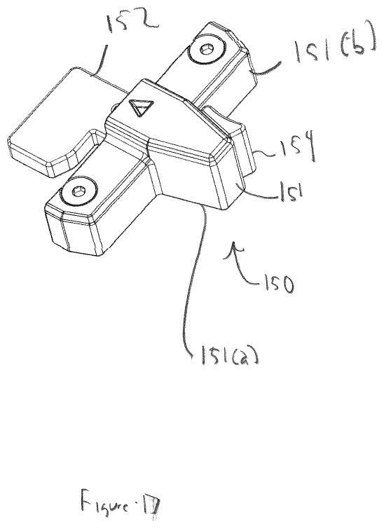

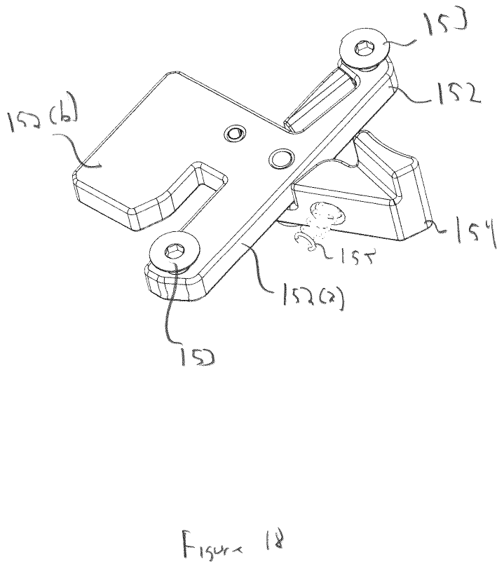

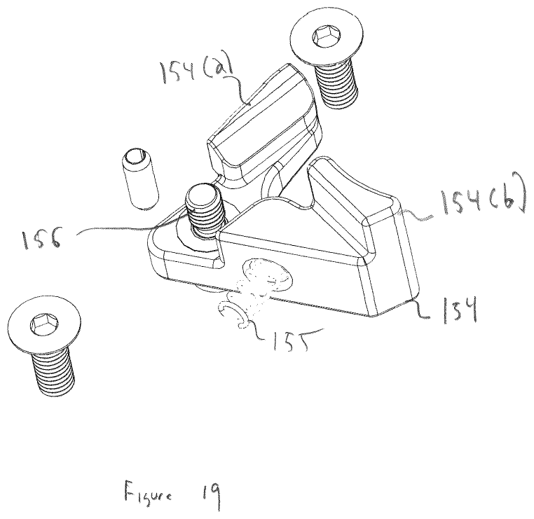

With further reference to FIGS. 16-20, slider lock 150 of a second embodiment is disclosed. Slider lock 150 is usable with second embodiment slider 140 (FIGS. 13A-B) which has a similar structure to that of slider 40 but includes rectangular opening 142(a) formed in surface 142, and does not include an equivalent to tab 41(b). Slider 140 is stamped out of sheet metal. Opening 141(a) is formed in wall 141. Slider 140 includes tabs 144 and 148(a) having similar structure to tabs 44 and 48(a) of the first embodiment. Slider lock 150 includes slider lock cover 151 made of plastic and having projection 151(a) extending rearwardly from main body portion 151(b). Cover 151 has an open leftward face, and the laterally rearward face of projection 151(a) is also open. H-shaped latch tooth 152 is made of metal and is secured to and beneath cover 151 by rivets 153 and includes main body portion 152(a) and slider lock element tab 152(b) extending leftward from main body portion 152(a) to form a gap. Latch tooth 152 extends leftward outward of the open face of lock cover 151 and also is disposed through both opening 5(b) in wall portion 5 and opening 141(a) in slider wall 141 such that slider lock element tab 152(b) extends behind wall portion 5(a) such that both wall portion 5(a) and slider wall 141 fit within the H-shaped defined by tooth 152, with main body portion 152(a) extending adjacent slider wall 141 and tab 152(b) extending adjacent wall portion 5(a).

Slider lock 150 further includes secondary latch 154 made of plastic which is pivotably disposed on pivot screw 156 which also extends through latch tooth 152 and in rectangular opening 142(a) to allow secondary latch 154, latch tooth 152 and lock cover 151 to jointly slide along surface 142 of slider 140. Secondary latch 154 includes pivoting lock arm 154(a) and push surface 154(b) extending at an angle thereto. Slider lock cover 151 is secured over both latch tooth 152 and secondary latch 154, with push surface 154(b) extending though the open face of projection 151(a) and tab 152(b) extending though the leftward face of main body portion 151(b). Coil spring 155 is disposed between secondary latch 154 opposite push surface 154(b) and an inner surface of projection 151(a) to bias push surface 154(b) outwardly of slider lock cover 151 and thus to bias lock arm 154(a) inwardly with respect to and within opening 5(a). The lower portion of pivot screw 156 extends in channel 142(a) formed in outward lower surface 142 to allow slider lock 150 to be slid laterally with respect to the surface.

When slider 140 is pushed to its inward (leftward) position slider lock 150 can be slid in the frontward direction such that slider lock element tab 152(b) is disposed behind wall portion 5(a). In particular, as shown FIG. 16(a), wall portion 5(a) and vertical surface 141 of slider 140 fit within the channel formed between main body 152(a) and tab 152(b) of latch tooth 152. That is, tab 152(b) is not aligned with openings 5(b) or 141(a). Therefore, slider 140 cannot be retracted to its outward position. In order to retract slider 140 to its outer position, slider lock 150 must be slid rearward such that tab 152(b) aligns with opening 5(b) in wall portion 5(a) and opening 141(a). In this position, slider 140 can be retracted to its maximum extent with tab 152(b) sliding through the openings. However, secondary latch 154 is biased by spring 155 such that lock arm 154(a) also is disposed in opening 5(a) adjacent tab 152(b), and prevents sliding motion of slider lock 150. Therefore, prior to sliding slider 140, push surface 154(b) of secondary latch 154 must first be pressed against the bias of spring 155 to retract lock arm 154(a) from openings 5(a) and 141(a). Therefore, since the user must first press surface 154(b) prior to sliding lock 150, lock 150 provides a double locking action against unintentional outward sliding of slider 140. When slider 140 is pushed inwardly from an outer position, the bias provided by coil spring 155 will automatically bias secondary latch 154 inwardly into openings 5(a) and 141(a) to provide the double locking action.

With reference to FIGS. 1A and 13A, an alternative embodiment of the dual connector and sliders are shown. Dual connector 100 includes slider 140 which as noted above is stamped out of sheet metal and which is substantially identical to slider 40 with several exceptions. Furthermore, instead of tabs 47(a), slider 140 includes front and rear tabs 147(a) which extend upwardly and outwardly from laterally inward lower surface 147. In particular, tabs 147(a) include s-shaped portion 147(b) which extends laterally outwardly and upwardly from lower surface 147 and horizontal portion 147(c) which extends laterally outwardly from s-shaped portion 147(b). Connector 100 includes opening 130 having downward walls 132 formed on the front and rear edges thereof. Oval openings 133 are formed in walls 132. Tabs 135 extend to the right of wall 132 defining gaps 137. Tab 136 extends laterally inwardly from wall portion 105 and defines gaps 138. Gaps 137 and 138 and the region below the rearward edge of opening 130 define a slide channel 131. (Only one wall 132, opening 132, tab 135, tab 136, gap 135 and gap 138 are shown, but identical structure is formed on the opposite edge of opening 130.) Slider 140 is disposed in opening 130 with each horizontal portion 147(c) disposed in one slide channel 131 to allow lateral movement of slider 140.

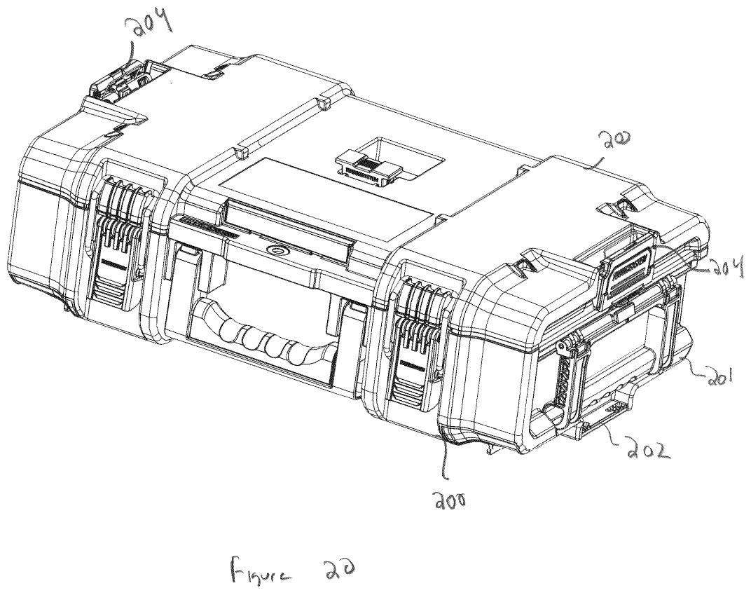

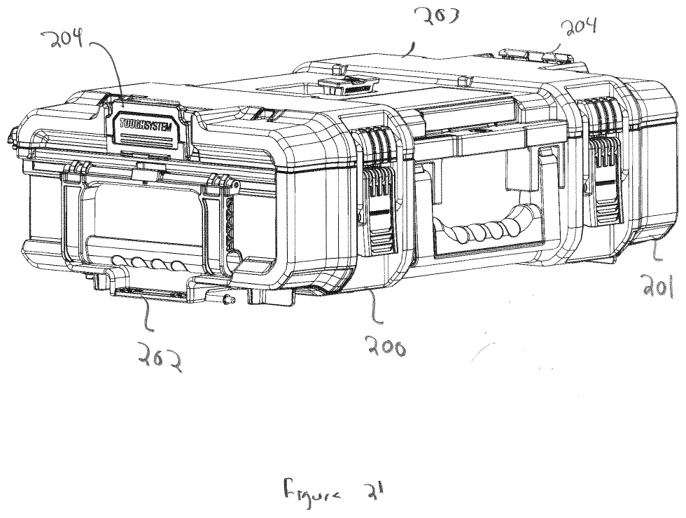

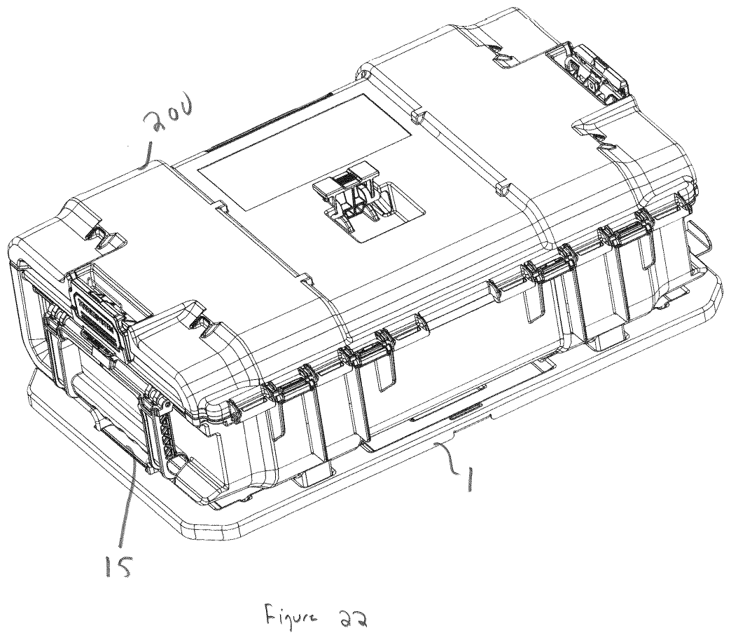

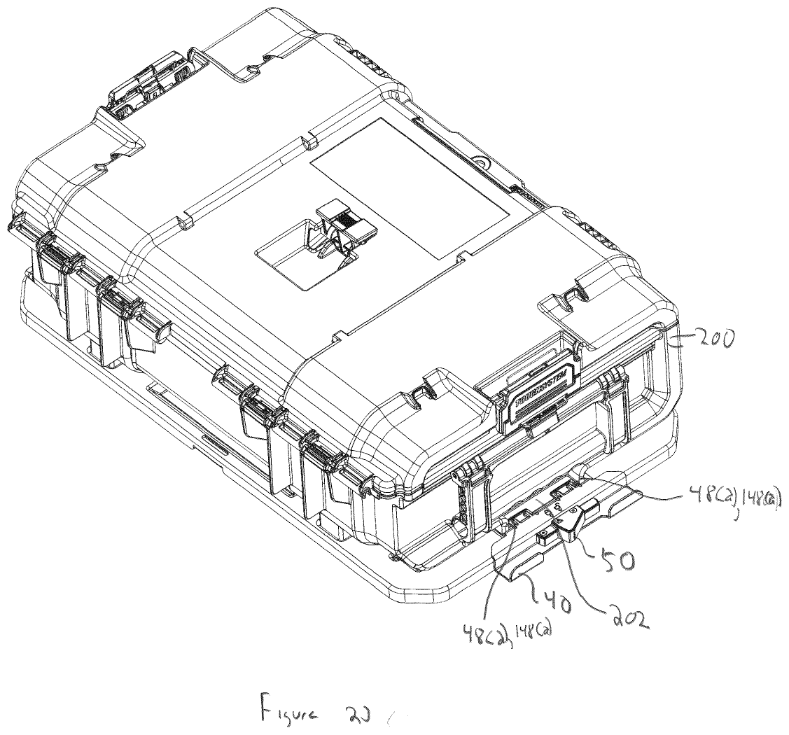

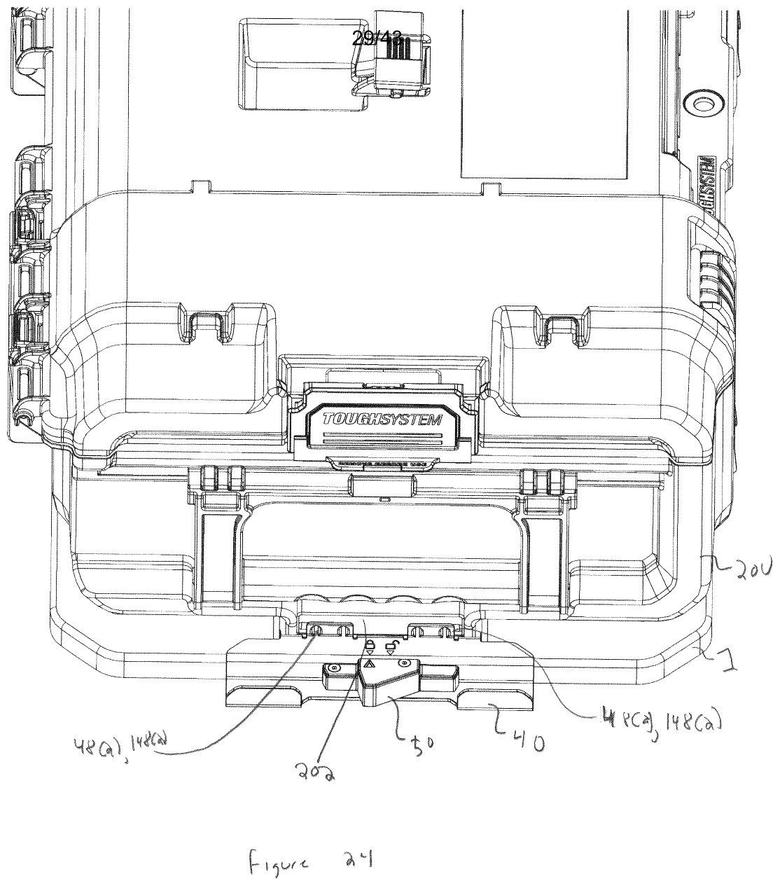

With further reference to FIGS. 20-21, storage case 200 is shown. Storage case 200 includes container 201 and cover 203 pivotable thereon. Steps 202 descend downwardly and outwardly from case 200 on each of the lateral sides thereof. Spring loaded latches 204 extend upwardly from cover 203 on the lateral sides thereof. With further reference to FIGS. 22-24, storage case 200 is disposable and may be secured on connector 1. When slider 40 (or 140) is pulled into its outer position, storage case 200 is disposed on the upper surface 11 of connector 1 with step 202 on one lateral side disposed beneath left outer peripheral raised ledge 15 and into the opening formed beneath ledge 15 to secure step 202 against vertical movement. Thereafter slider 40 (or 140) is pushed inwardly until slider locking tabs 48(a) (or 148(a)) are disposed over step 202 on the opposite lateral side to prevent vertical movement thereof. Since both steps 202 are secured against vertical or horizontal movement relative to connector 1, storage case 200 is secured thereon. When slider 40 (or 140) is pulled outwardly, after locking mechanism 50 (or 150) is moved to the position where it does not preclude movement of slider 40 (or 140), locking tabs 48(a) (or 148(a)) are moved from their position overlying step 202, allowing case 200 to be moved such that raised ledge 15 does not overly the other step 202, and case 200 can be removed from connector 1.

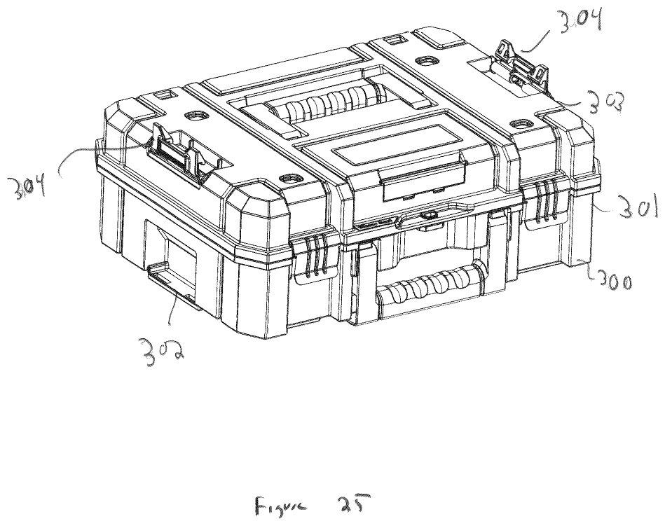

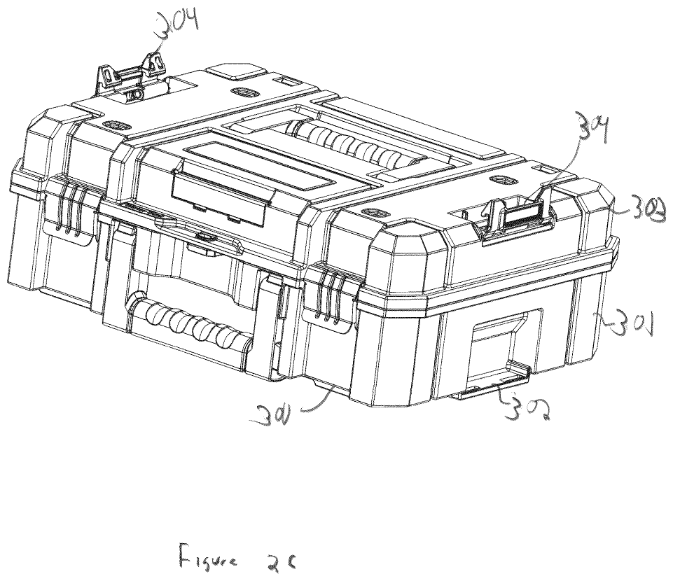

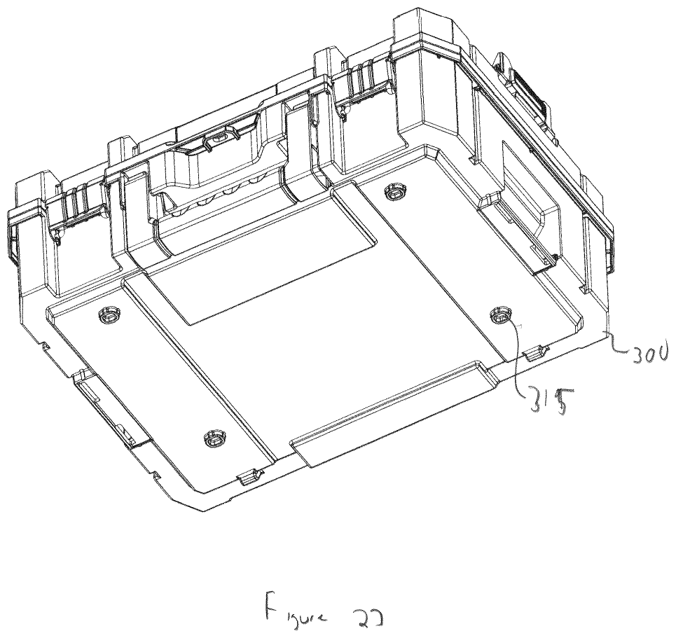

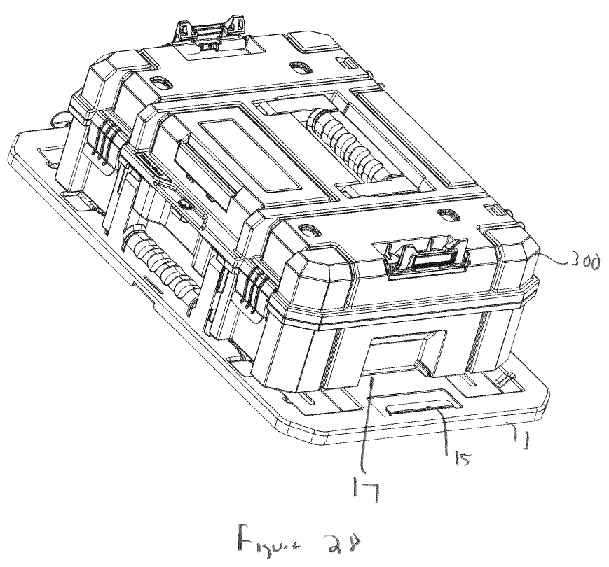

With reference to FIG. 25-28, storage case 300 is disclosed. Case 300 is from a different stackable storage system than case 200. Case 300 is similar in structure to case 200 and includes container 301 and cover 303 pivotable thereon. Steps 302 descend downwardly and outwardly from container 301 on each of the lateral sides thereof. Swing latches 304 extend upwardly from cover 303 on the lateral sides thereof. However, the length of case 400 (in the direction between steps 302) is less than that of case 200 between steps 202. Similarly, the widths of steps 302 are less than that of steps 202 of case 200. When slider 40 (or 140) is pulled into its outer position, storage case 300 may be disposed on the upper surface 11 of connector 1 with step 302 on one lateral side disposed beneath left inner peripheral raised ledge 17. Thereafter slider 40 (or 140) is pushed inwardly until slider locking tabs 44 (or 144) are disposed over step 302 on the opposite lateral side. Since both steps 302 are secured against vertical or horizontal movement relative to connector 1, storage case 300 is secured thereon. Since the distance between tabs 44 (or 144) and ledge 17 is less than the distance between tabs 48(a) (or 148a) and ledge 15, slider 40 (or 140) are pushed to the same extent to allow the two different sized cases to be secured.

In this manner, connector 1 can secure storage cases having two different lengths in the longitudinal direction. Storage case 300 may also include four projections 315 extending downwardly from the lower surface of container 301. Projections 315 fit within corresponding through holes 19 to further secure case 300 against lateral movement relative to connector 1.

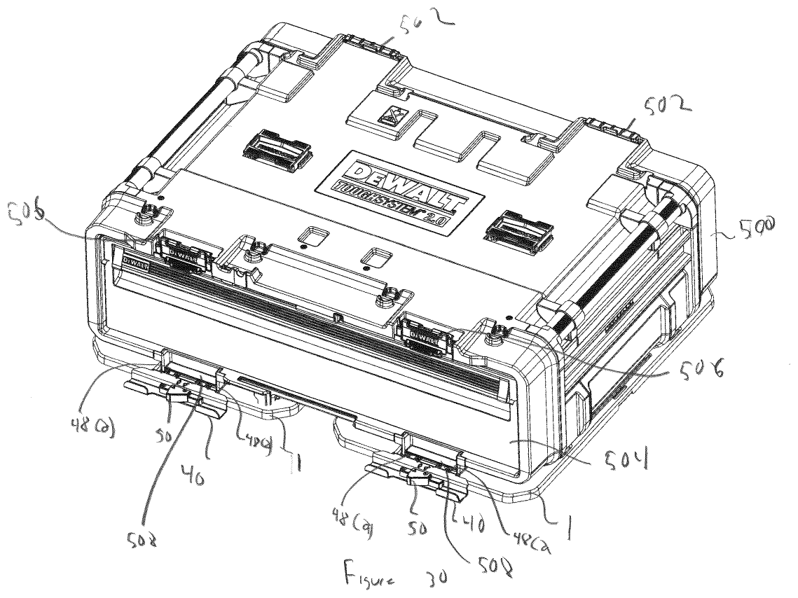

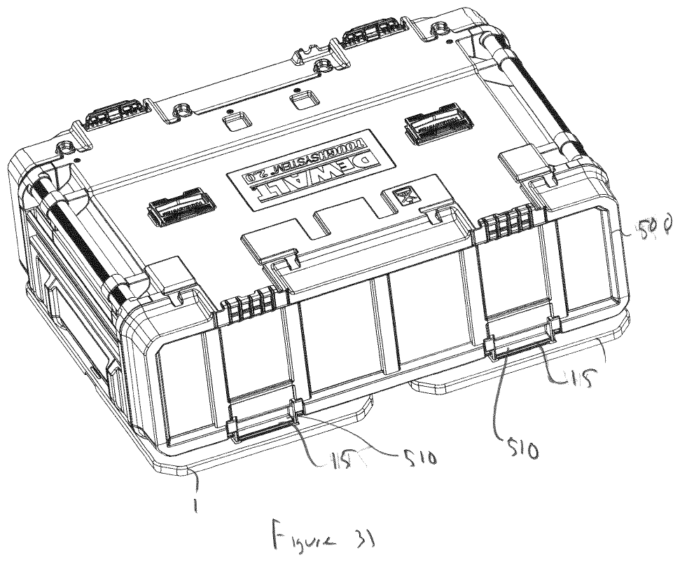

With reference to FIGS. 30-31, drawered storage chest 500 includes storage drawer 504, left and right upper rear overhanging ledges 502, and left and right upper spring-loaded latches 506. Drawered storage chest 500 further includes left and right front lower steps 508 disposed below latches 506 and left and right rear steps 510 disposed below ledges 502. The width of chest 500 in the lateral direction is substantially identical to the length in the longitudinal direction of container 200 and the length of chest 500 in the longitudinal direction is substantially equal to or greater than the width of container 200 in the lateral direction. Therefore, drawered storage chest 500 can be disposed upon two connectors 1 which are disposed adjacent to each other along their longitudinal sides. Outer peripheral ledge 15 of one connector 1 is disposed over left rear step 510 of chest 500, and outer peripheral ledge 15 of the other connector 1 is disposed over right rear step 510 of chest 500. Slider 40 of one connector 1 is slid inwardly so that front and rear tabs 48(a) over left lower step 508, and slider 40 of the other connector 1 is slid inwardly so that front and rear tabs 48(a) are disposed over right lower step, to secure chest 500 on both connectors 1. In this manner, two connectors can be used to connect a storage container from a third storage system.

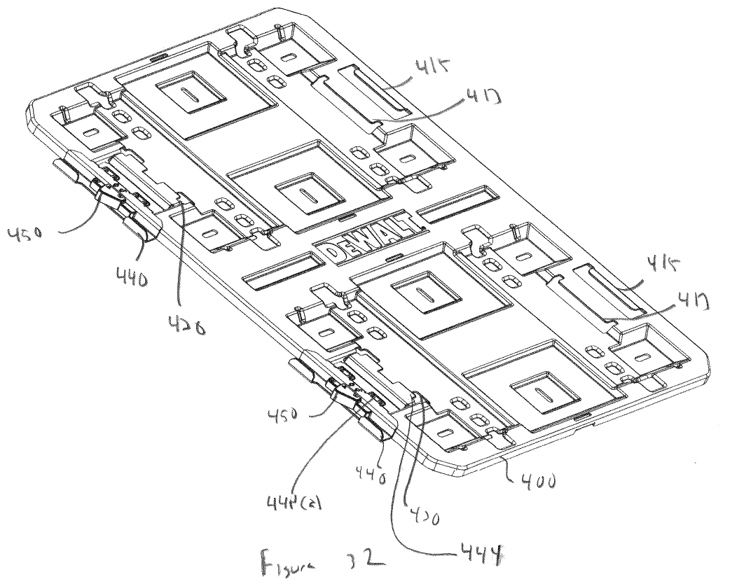

With reference to FIG. 32, an alternative connector 400 is shown. The structure of connector 400 is essentially two connectors 1 attached along the longitudinal sides. Connector 400 includes two sliders 440 having the same structure of slider 40, with each slider 440 disposed in a through opening 430 having the same structure as through opening 30. Through openings 430 and thus slider 440 are disposed in a spaced apart relationship along the front longitudinal side of connector 440. One rear outer peripheral ledge 415 and one inner peripheral ledge 417 having the same structure and locations of as ledges 15 and 17, respectively, are disposed opposite each slider 440. One slider lock 450 having the same structure as slider 50 is disposed on each slider 440. In all other respects, connector 400 has the same components as connector 1, including pairs of outer tabs 448(a) and inner tabs 444 formed on slider 440. However, sliders 440 and tabs 448(a),444 and ledges 415,417 are disposed on the longitudinal sides of connector 400 while corresponding slider 40 and ledges 15,17 are disposed on the lateral sides of connector 1.

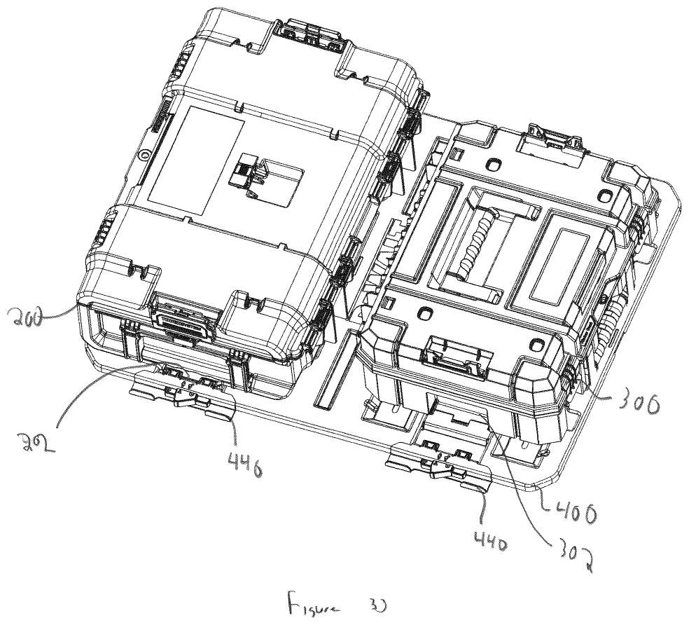

With reference to FIG. 33, container 200 and container 300 can simultaneously be disposed on connector 400. Steps 202 of container 200 are disposed beneath outer tabs 448a of one slider 440 and opposite outer peripheral ledge 415, and container 300 is disposed beneath inner tabs 444 of the other slider 440 and opposite inner peripheral ledge 417. In this manner, two containers from different systems and having different sizes can be secured on one connector.

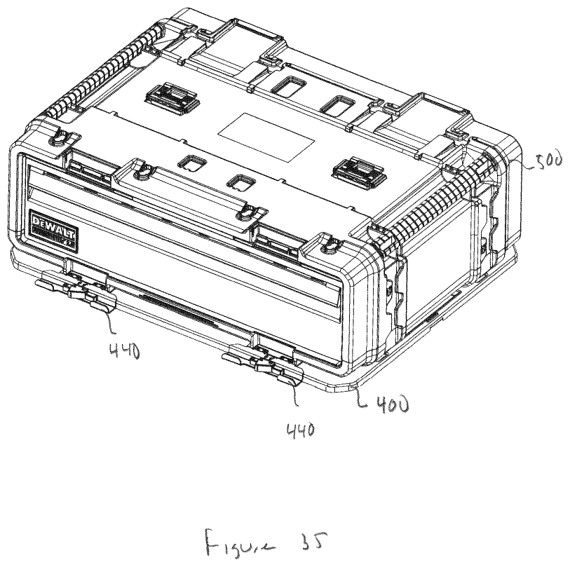

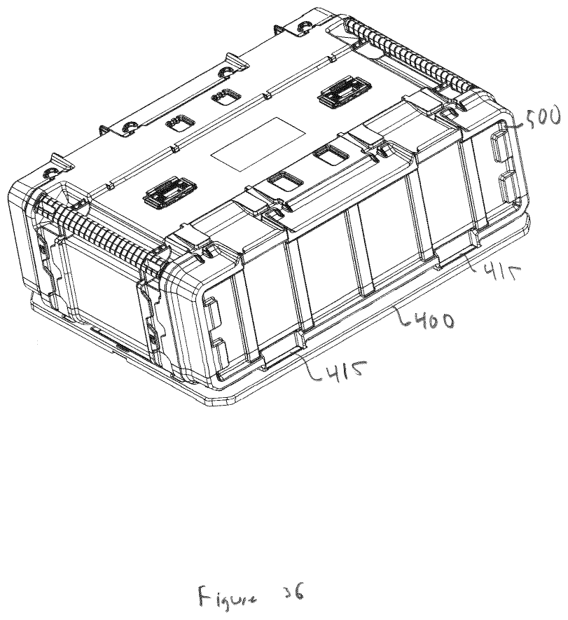

With reference to FIGS. 35-36, drawered storage container 500 also can be secured on connector 400. The tabs of left and rights sliders 440 are secured over left and right front lower steps 508 disposed below latches 502, and left and right ledges 415 are secured over left and right rear steps 510.

1. A connector comprising:
a main body;
a first peripheral ledge formed on said main body and extending adjacent one side of said main body;
a second peripheral ledge formed on said main body, said second peripheral ledge disposed inwardly of said first peripheral ledge;
a slider slidably disposed on an opposite side of said main body, said slider having a slider body slidable between an outer position relative to said main body and an inward position relative to said main body, said slider body including a first inwardly extending tab and a second inwardly extending tab, said second tab disposed at a location which is inward of said first tab; wherein,
a first container having a first container first step extending downwardly from one side and a first container second step extending downwardly from an opposite side can be secured to said main body with said first container first step secured beneath said first peripheral ledge and said first container second step secured beneath said first tab, and a second container having a second container first step extending downwardly from one side and a second container second step extending downwardly from an opposite side can be secured to said main body with said second container first step secured beneath said second peripheral ledge and said second container second step secured beneath said second tab.

2. The connector recited in claim 1, wherein said slider is slid to an inward position to secure either said first container second step beneath said first tab or to secure said second container second step beneath said second tab.

3. The connector recited in claim 2, wherein, said main body includes a wall on said opposite side having a wall opening formed therethrough, said main body including a connector opening formed therethrough and defined on one side by said wall, said slider including a slider opening and disposed in said connector opening with said slider opening and said wall opening overlapping, said connector further including a slider lock disposed on said slider and including a lock tooth extending through both said slider opening and said wall opening and having a lock tooth tab, wherein, said slider lock is movable between a first slider lock position in which said lock tooth tab is aligned with both said slider opening and said wall opening such that said slider may be slid outwardly from said inward position with said lock tooth tab moving through said slider opening and said wall opening, and a second slider lock position in which said lock tooth tab is not aligned with said slider opening and said slider may not be slid outwardly from said inward position.

4. The connector recited in claim 3, said slider lock further comprising a secondary latch including a lock arm, said secondary latch movable between a first secondary latch position in which said lock arm is disposed in said slider opening adjacent said lock tooth tab to preclude said slider lock from being moved from said second slider lock position to said first slider lock position, said secondary latch movable to a second secondary latch position in which said lock arm is not disposed in said slider opening adjacent said lock tooth tab and said slider lock is not precluded from being moved from said second slider lock position to said first slider lock position.

5. The connector recited in claim 4, said secondary latch pivotably mounted on said lock tooth.

6. The connector recited in claim 5, said secondary latch biased into said first secondary latch position.

7. A connector comprising:
a main body;
a peripheral ledge formed on said main body and extending adjacent one side of said main body;
a slider slidably disposed on an opposite side of said main body, said slider having a slider body slidable between an outer position relative to said main body and an inward position relative to said main body, said slider body including an inwardly extending tab;
wherein, a container having a container first step extending downwardly from one side and a container second step extending downwardly from an opposite side can be secured to said main body with said container first step secured beneath said peripheral ledge and said container second step secured beneath said tab.

8. The connector recited in claim 7, wherein, said main body is stamped out of a sheet of metal.

9. A system comprising a connector and a storage container, said connector comprising:
a main body;
a first peripheral ledge formed on said main body and extending adjacent one side of said main body;
a slider slidably disposed on an opposite side of said main body, said slider having a slider body slidable between an outer position relative to said main body and an inward position relative to said main body, said slider body including an inwardly extending tab;
said storage container comprising two first container steps extending downwardly from one side and two second container steps extending downwardly from an opposite side, one of said first container steps disposed opposite one of said second container steps to create a first container step pair and the other of said first container steps disposed opposite the other of said second container steps to create a second container step pair, wherein,
said storage container can be secured simultaneously upon the main bodies of two of said connectors with said first container step of said first container step pair secured beneath said peripheral ledge of a first of said connectors and said second container step of said first container step pair secured beneath said tab of said first of said connectors, and with said first container step of said second container step pair secured beneath said peripheral ledge of a second of said connectors and said second container step of said second container step pair secured beneath said tab of said second of said connectors.

10. A connector comprising:
a main body;
a first outer peripheral ledge and a second outer peripheral ledge formed on said main body and extending adjacent one side of said main body;
a first inner peripheral ledge and a second inner peripheral ledge formed on said main body, said first inner peripheral ledge extending inwardly of said first outer peripheral ledge to form a first peripheral ledge pair and said second inner peripheral ledge extending inwardly of said second outer peripheral ledge to form a second peripheral ledge pair;
a first slider slidably disposed on an opposite side of said main body and disposed opposite of said first peripheral ledge pair, said first slider slidable between an outer position relative to said main body and an inward position relative to said main body, said first slider including a first slider first inwardly extending tab and a first slider second inwardly extending tab, said first slider second inwardly extending tab disposed at a location which is laterally inward of said first slider first inwardly extending tab to form a first slider inwardly extending tab pair which is disposed opposite said first peripheral ledge pair; and
a second slider slidably disposed on an opposite side of said main body and disposed opposite of said second peripheral ledge pair, said second slider slidable between an outer position relative to said main body and an inward position relative to said main body, said second slider including a second slider first inwardly extending tab and a second slider second inwardly extending tab, said second slider second inwardly extending tab disposed at a location which is laterally inward of said second slider first inwardly extending tab to form a second slider inwardly extending tab pair which is disposed opposite said second peripheral ledge pair.

11. The connector recited in claim 10, wherein;
a first container having a first container first step extending downwardly from one side and a first container second step extending downwardly from an opposite is securable on said connector with said first container first step secured beneath one of said peripheral ledges of said first peripheral ledge pair and said first container second step secured beneath one of said inwardly extending tabs of said first slider inwardly extending tab pair, and a second container having a second container first step extending downwardly from one side and a second container second step extending downwardly from an opposite is simultaneously securable on said connector with said second container first step secured beneath one of said peripheral ledges of said second peripheral ledge pair and said second container second step secured beneath one of said inwardly extending tabs of said second slider inwardly extending tab pair.
